(19) United States
(12) Patent Application Publication
(10) Pub. No.: US 2004/0033011 A1
(43) Pub. Date: Feb. 19, 2004

(54) Optical attenuator

(76) Inventor: Igal Roberto Chertkow, Ashdod (IL)

Correspondence Address: PENNIE AND EDMONDS, 1155 AVENUE OF THE AMERICAS, NEW YORK, NY, 100362711

(21) Appl. No.: 10/218,746

(22) Filed: Aug. 13, 2002

(51) Int. Cl. G02B 6/26

(52) U.S. Cl. 385/19

(57) ABSTRACT

A microelectromechanical system (MEMS) optical device is introduced which includes a mirror constructed on a substrate. The mirror is movable parallel to the surface of the substrate to control whether an input ray passes undisturbed or is reflected to an alternate output. In one embodiment, a variation on a comb-drive designed to produce larger forces than usual uses an envelope-like electrode into which the mirror is drawn. In a second embodiment, a mirror is supported on flexible beams which are attracted or repelled by electrostatically charging curved electrodes thereby actuating the mirror. In a third embodiment, a magnetic field around the switch induces lateral forces when electric current flows in conductive supporting beams.

### CROSS-REFERENCE TO RELATED APPLICATIONS

This application claims benefit under 35 U.S.C. §120 of priority from U.S. Patent application Ser. No. 09/869,144, filed Jun. 26, 2001, entitled “Opto-Mechanical Valve and Valve Array for Fiber-Optic Communication,” which is a national stage filing of International Patent Application No. PCT/US00/03354, filed Feb. 10, 2000 designating the United States, entitled “Opto-Mechanical Valve and Valve Array for Fiber-Optic Communication,” which claimed priority to the following U.S. Provisional Patent Application: No. 60/119,625, filed Feb. 11, 1999, entitled “Opto-Mechanical Valve and Valve Array for Fiber-Optic Communication,” and No. 60/123,865, filed Mar. 11, 1999, entitled “Opto-Mechanical Valve and Valve Array for Fiber-Optic Communication.” The contents of each of the above applications is hereby incorporated by reference in its entirety for each of its teachings and embodiments.

This application also claims benefit under 35 U.S.C. §120 of priority from U.S. patent application Ser. No. 09/619,013, filed Jul. 19, 2000, entitled “Microelectromechanical Device with Moving Element,” which: (1) claimed benefit under 35 U.S.C. §120 of priority from U.S. patent application Ser. No. 09/869,144, filed Jun. 26, 2001, entitled “Opto-Mechanical Valve and Valve Array for Fiber-Optic Communication,” which is a national stage filing of International Patent Application No. PCT/US00/03354, filed Feb. 10, 2000 designating the United States, entitled “Opto-Mechanical Valve and Valve Array for Fiber-Optic Communication,” which claimed priority to the following U.S. Provisional Patent Application: No. 60/119,625, filed Feb. 11, 1999, entitled “Opto-Mechanical Valve and Valve Array for Fiber-Optic Communication,” and No. 60/123,865, filed Mar. 11, 1999, entitled “Opto-Mechanical Valve and Valve Array for Fiber-Optic Communication,” each of which is hereby incorporated by reference in its entirety; and (2) which claimed priority to the following U.S. Provisional Patent Application: No. 60/144,628, filed Jul. 20, 1999, entitled “Enhancements to the ‘Opto-Mechanical Valve and Valve-Array for Fiber Optic Communication’ by Applying Bistable Actuating and Lock Element, Frictionless, etc.,” No. 60/170,492, filed Dec. 13, 1999, entitled “Plane Motion Opto-Mechanical Wave Valves,” and No. 60/170,494, filed Dec. 13, 1999, entitled “Fabrication Methods For a 3D Configuration Array of Elements From a Set of 2D Array.” The contents of each of the above applications is hereby incorporated by reference in its entirety for each of its teachings and embodiments.

This application also claims benefit under 35 U.S.C. §120 of priority from U.S. patent application Ser. No. 10/030,265, filed Jan. 08, 2002, entitled “Opto-Mechanical Valve and Valve Array for Fiber-Optic Communication,” which is a national stage filing of International Patent Application No. PCT/IL00/00425, filed Jul. 19, 2000 designating the United States, entitled “Opto-Mechanical Valve and Valve Array for Fiber-Optic Communication,” which claimed priority to the following U.S. Provisional Patent Application: No. 60/144,628, filed Jul. 20, 1999, entitled “Enhancements to the Opto-Mechanical Valve and Valve Array for Fiber-Optic Communication, by Appling Bistable Actuating and Lock Element,” No. 60/170,492, filed Dec. 13, 1999, entitled “Plane Motion Opto-Mechanical Wave Valves” No. 60/170,482, filed Dec. 13, 1999, entitled “3D Configuration Switching Device,” and No. 60/170,494, filed Dec. 13, 1999, entitled “Fabrication Methods For a 3D Configuration Array of Elements From a Set of 2D Array.” The contents of each of the above applications is hereby incorporated by reference in its entirety for each of its teachings and embodiments.

### FIELD AND BACKGROUND OF THE INVENTION

The present invention relates to switching in optical networks such as optical communications networks and, more particularly, to an optomechanical valve and to arrays of optical valves generally and this valve in particular.

An essential component of any communications system is a switch to enable signal routing. Various types of devices are used for optical switching. Some transform the optical signal into the electrical domain, where switching is done and then retransform back to the optical domain. Others use integrated optics to perform switching, using materials such as lithium niobate. These devices are relatively expensive, their minimum size is limited by the physics of optical wave-guides, they are strongly dependent on wavelength, and they suffer from cross-talk and signal attenuation.

One way to overcome many of these limitations is to use mechanical optical switches (Motamedi M. E. et al, “Micro-opto-electro-mechanical devices and on-chip optical processing”, Optical Engineering vol. 36 No. 5, May 1997, page 1282, and other articles in this issue of the journal). Micro-mechanical switches are not wavelength dependent and can be very compact. Signal loss occurs mainly at the input from and output into the fibers (which is about the same as for other switching technologies). Air accounts for only a very small portion of the attenuation. An N×N switch, that can route any of its N inputs to any of its N outputs, is simple to realize by an array of mirrors placed in the ray paths. By suitably actuating a mirror, or series of mirrors, a ray may be switched into any desired output path. There is no interference among the N inputs, since light-ray paths cross without interaction (Hecht J., “Optical switching promises cure for telecommunications logjam”, Laser Focus World, September 1998, page 69). There is thus almost no cross-talk between data lines.

The task is mainly the production of tiny mirrors to use as switches in these arrays. Micromachined devices are capable of fulfilling the task, provided that the micro-machining produces optical-grade mirrors to reduce losses. Actuation needs to be fast, simple, and allow reproducible and accurate alignment of the beam inputs and outputs as the mirrors bend the ray. In addition, the ability to deploy large arrays of mirrors is an essential feature of the system. All of these affect switching losses and utility. Previous art devices, although ingenious, were not able to achieve all of these requirements together. (See, for example: Toshiyoshi H. et al, “Electrostatic micro-torsion mirrors for an optical-switch matrix”, Journal of Microelectromechanical Systems, vol. 5 No. 4, December 1996, page 231; and Marxer C. et al, “Vertical mirrors fabricated by deep reactive ion etching for fiber-optic switching applications”, Journal of Microelectromechanical Systems, vol. 6 No. 3, September 1997, page 277.)

The valve and valve array of the present invention overcome the shortfalls of previous art.

### SUMMARY OF THE INVENTION

A microelectromechanical optical switch that transfers or reflects an input ray using a movable mirror constructed on the surface of a substrate and oriented at 45° to the ray's direction is presented. This switch is actuated parallel to the substrate's surface by electrostatic, magnetic, thermal, piezoelectric, or other means. In the case of electrostatic actuation, an envelope-style electrode may be used to obtain larger forces than are obtained in prior art configurations such as comb actuators, to produce faster switching. Designing the electrode edges to have a large perimeter or an irregular shape such as a fractal shape can increase this force even more. It should be noted that the terms “valve” and “switch” are used interchangeably herein.

Arrays of switches may switch rays from a plurality of inputs to any of a plurality of outputs. A three-dimensional switch array disclosed allows this switching to be done with shorter ray paths and fewer mirrors.

A wavelength separating and combining device that can separate a multi-wavelength beam into a bundle of parallel single-wavelength rays and recombine them is also disclosed.

Usual fabrication methods are employed but enhanced mirror alignment and performance are achieved by fabricating mirrors on the surface of a wafer. A novel method is disclosed for fabricating 2D and 3D arrays, by bonding several laterally displaced wafers on top of one another.

According to the present invention there is provided an optical switch for switching a light ray including: (a) a substantially planar substrate having a portion that is transparent to the light ray; (b) a switching element having at least one reflective surface substantially parallel to the substrate; and (c) a mechanism for moving the switching element in a direction parallel to the substrate between (i) a first position wherein the light ray traverses the transparent portion of the substrate to a first outlet and (ii) a second position wherein the light ray is blocked from traversing the transparent portion of the substrate and reflected by the reflective surface to a second outlet.

According to one embodiment of the present invention the mechanism moves the switching element substantially rectilinearly.

According to another embodiment of the present invention the mechanism moves the switching element substantially curvilinearly.

According to one embodiment of the present invention the substrate includes an opaque portion opposite which the switching element is located when in the first position and a transparent portion opposite which the switching element is located when in the second position.

According to another embodiment of the present invention the substrate includes a second transparent portion opposite which the switching element is located when in the first position.

According to the present invention there is provided a method for switching either of two light rays wherein: (a) the first ray is switched to an output while the second ray passes unswitched to another output when the switching element is in the first position and (b) the first ray passes unswitched to the latter output while the second ray is switched to the former output when the switching element is in the second position.

According to one embodiment of the present invention the mechanism includes shape memory alloys.

According to one embodiment of the present invention the mechanism is thermal.

According to another embodiment of the present invention the mechanism is piezoelectric.

According to another embodiment of the present invention the mechanism is electrostatic.

According to another embodiment of the present invention the mechanism is magnetic.

According to one embodiment of the present invention the electrostatic mechanism includes: (a) two planar electrodes serving as stators (i) parallel to the substrate, (ii) fixed to the substrate and insulated therefrom, (iii) having substantially equal shape and dimensions, and (iv) electrostatically chargeable, with same polarity; (b) a third, insulated, planar electrode that: (i) is movable in a plane parallel to and between the stators in a path such that the third electrode may be at rest in a first position substantially between the stators and in a second position substantially outside the stators, and (ii) is attached to the switching element; and (c) a mechanism for alternately charging the electrodes in: (i) a first charge configuration wherein a charge on the third electrode is of opposite polarity to a charge on the stators and (ii) a second charge configuration wherein a charge on the third electrode is of same polarity as a charge on the stators.

According to one embodiment of the present invention the stator edges where between the path passes are straight.

According to another embodiment of the present invention these stator edges, and/or the leading edge of the third electrode, are circular.

According to another embodiment of the present invention these stator edges, and/or the leading edge of the third electrode, have an irregular form such as a fractal form.

According to another embodiment of the present invention the mechanism includes: (a) one or more stators, each of which: (i) is fixed to the substrate and insulated therefrom, (ii) has a circular segment shape, the circle lying in a plane parallel to a surface of the substrate, and (iii) is electrostatically chargeable; (b) at least one supporting beam for the switching element, each beam being: (i) flexible, (ii) attached at a point to the switching element and at another point to at least one of the stators, (iii) insulated from that stator, and (iv) electrostatically chargeable, and (c) a mechanism for alternately charging the stators and the beams in: (i) a first charge configuration wherein a charge on the beams is of opposite polarity to a charge on the stators and (ii) a second charge configuration wherein a charge on the beams is of same polarity as a charge on the stators.

According to another embodiment of the present invention the mechanism includes a beam attached at a center to the stator and at both ends thereof to the switching element.

According to another embodiment of the present invention the stators have a quadrant shape and each beam is attached at one end to a stator and at the other end to a switching element.

According to another embodiment of the present invention the stators include pairs of quadrant-shaped components separated by and tangential to the beam at the point of attachment thereto and so aligned that a radial boundary of each is collinear through that point of attachment.

According to another embodiment of the present invention the beams are bistable.

According to another embodiment of the present invention the mechanism includes: (a) a magnetic field perpendicular to the substrate; (b) one or more supporting beams for the switching element, each beam being: (i) flexible, (ii) bistable, (iii) attached at an end to the switching element and at another end to the substrate, and (iv) electrically conductive; and (c) a mechanism for causing an electric current to pass through the beams.

According to one embodiment of the present invention the magnetic field is produced by a permanent magnet.

According to another embodiment of the present invention the magnetic field is produced by an electro-magnet.

According to another embodiment of the present invention there is provided a two dimensional matrix of optical switches, arranged in rows and columns wherein a switch is positioned at least some intersections of each row with each column.

According to another embodiment of the present invention, each switch is oriented to be moveable in a direction of motion obliquely, preferably at an angle of 45, to the rows and columns, and is actuatable independently of each other switch.

According to another embodiment of the present invention, each switch is oriented to be moveable in a direction of motion in and out of the plane defined by the rows and columns, and is actuatable independently of each other switch.

According to another embodiment of the present invention, an optical switches is positioned at each intersection of each row with each column.

According to another embodiment of the present invention there is provided a stationary reflective element located at a diagonal of this matrix in place of the switching elements there located and wherein switching elements are positioned only on a reflective side of the stationary reflective element.

According to the present invention there is provided a matrix of switches wherein at least one of the switches includes two reflective surfaces on opposite sides thereof.

According to the present invention there is provided a matrix of switches wherein at least one of the reflective surfaces of one of the switches is partly transmissive.

According to the present invention there is provided a three-dimensional switch array including a plurality of stacked, substantially identical, two-dimensional matrices of optical switches wherein each switch of one matrix is located opposite a corresponding switch of another matrix.

According to another embodiment of the present invention there is provided a three dimensional switch array including a plurality of stacked, substantially identical, two dimensional matrices of optical switches having a stationary reflective element at a diagonal wherein each switching element of one matrix is located opposite a corresponding switch of another matrix.

According to the present invention there is provided a three-dimensional switch array complex including a plurality of successive three-dimensional switch arrays wherein for each switch array except the first switch array: (a) an input face of that switch array faces and is parallel to an output face of a preceding switch array, (b) numbers of rows and columns of each succeeding switch array match numbers of columns and rows respectively of each preceding switch array, and (c) each succeeding switch array is oriented such that the rows and columns thereof are substantially aligned to the columns and rows of the preceding switch array.

According to the present invention there is provided a wavelength separator/recombiner including a first and second mutually parallel diffraction gratings, each including a plurality of diffractive elements on a surface thereof, the two gratings being offset so that a single input beam of light that includes a plurality of wavelengths and that is incident on the surface of one of the gratings, is diffracted by the gratings to produce one separate output beam of light for each wavelength with the separated beams being mutually parallel.

According to the present invention there is provided a method of demultiplexing a collimated wavelength-multiplexed beam and switching individual wavelength components to respective output ports, including the steps of: (a) directing the beam into the wavelength separator and (b) introducing the separated wavelength components into a switch array complex, and (c) switching the components to respective output ports thereof.

According to the present invention there is provided a method of multiplexing a plurality of individual wavelength rays into a single beam including the steps of: (a) introducing the individual wavelength rays into respective input ports of a three-dimensional switch array, (b) switching the rays, as required, to output ports of the array in a suitable alignment for introducing the rays into a wavelength recombiner for combining into a single multiplexed beam.

According to the present invention there is provided a method of fabricating the three dimensional switch array including the steps of: (a) fabricating wafers containing independently actuatable optical switches arranged in equispaced rows and columns, the number of rows thereof being equal to the number of component two-dimensional switch matrices, (i) the first wafer having one column, and (ii) each succeeding wafer having one more column than a preceding wafer, until (iii) a last wafer having a number of columns equal to a number of input ports in each layer of the stack; (b) aligning the wafers with respect to one another such that: (i) the rows are all in parallel planes, (ii) the columns are parallel, and (iii) a group of columns in a succeeding wafer is centered opposite a group of columns in the preceding wafer; (c) bonding the aligned substrates together; and (d) dicing the bonded stack substantially parallel to the resulting square cross-section switch array and also substantially parallel to said columns.

According to another embodiment of the present invention there is provided a method of fabricating the three-dimensional switch array including further steps, beyond those of the preceding paragraph, of: (a) adding succeeding wafers, each said wafer, as before, containing independently actuatable optical switching elements arranged in equispaced rows and columns, the number of rows thereof being equal to the number of component two dimensional switch matrices, and each succeeding wafer having one less column than a preceding wafer, and a final wafer having one column; (b) aligning the wafers with respect to one another such that: (i) the rows are all in parallel planes, (ii) the columns are parallel, and (iii) a group of columns in a succeeding wafer is centered opposite a group of columns in the preceding wafer; (c) bonding the aligned substrates together; and (d) dicing the bonded stack substantially parallel to the resulting square cross-section switch array and also substantially parallel to said columns.

According to another embodiment of the present invention there is provided a method of including a planar static reflecting element located in place of the wafer with the largest number of columns, whereupon dicing is performed, parallel to the resulting rows and columns and also parallel to the static mirror and on a non-reflective side thereof.

Although the two-dimensional matrix of the present invention and the three-dimensional array of the present invention are described below in terms of the optical switch of the present invention, the scope of the present invention includes such matrices and arrays based on any kind of optical switch.

### BRIEF DESCRIPTION OF THE DRAWINGS

The invention is herein described, by way of example only, with reference to the accompanying drawings, wherein:

FIG. 1 shows the general switch layout and basic switching motions;

FIG. 2 shows switch zones;

FIG. 3 shows basic switching actions;

FIG. 4 illustrates how to obtain a switch that can direct two parallel inputs to separate outlets, by operating a switching element entirely within an optically active zone;

FIG. 5 shows envelope actuation of a switching element;

FIG. 6 presents two different possible designs for curved beam actuation;

FIG. 7 illustrates the use of magnetic actuation;

FIG. 8 shows some basic switching actions with two crossed rays;

FIG. 9 presents a two variations of a basic switch array;

FIG. 10 shows a schematic view of multi-layer switch array;

FIG. 11 illustrates a 3D switching method involving two multi-layer switch arrays;

FIG. 12 shows a wavelength-separation/recombiner device;

FIG. 13 illustrates basic switch fabrication processes; and

FIG. 14 shows fabrication of a 3D switch array.

### DESCRIPTION OF THE PREFERRED EMBODIMENTS

Introduction.

The wave valve of the present invention is intended to be used in fiber-optic communications. It employs mirrors to perform the switching. Mirrors have the advantage of being substantially insensitive to wavelength. The active environment is a gas such as air, or a vacuum. This non-interfering environment allows ray paths to cross without interaction, so there is no cross-talk and almost no attenuation by the medium. Most of the losses occur during light transfer from and into the fiber at the switch/fiber interfaces. Losses are also introduced by spreading of the beam in space, but use of appropriate lenses and short distances can reduce these.

The mirrors should be small, to allow fast response, low losses, and compactness. The mirrors, in general, are micro-machined and, in order to reduce losses, are designed to be very smooth. They are generally planar and placed on a smooth wafer substrate, in contrast to previous art that etches the mirrors into the wafer bulk. In order to enhance switching speed, the mirror moves parallel to the substrate, thus reducing the influence of air resistance. This placement also minimizes small deviations of the mirror from the normal (90) to the substrate that account for part of the losses introduced in prior art systems. The principles presented here are designed to give higher actuating forces, thus allowing a faster response than previous art.

Valve Configuration and Operation.

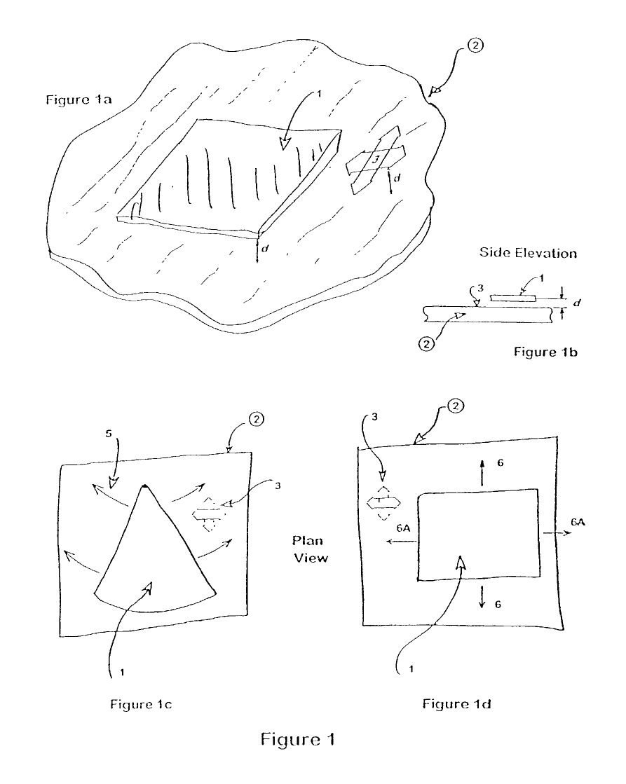

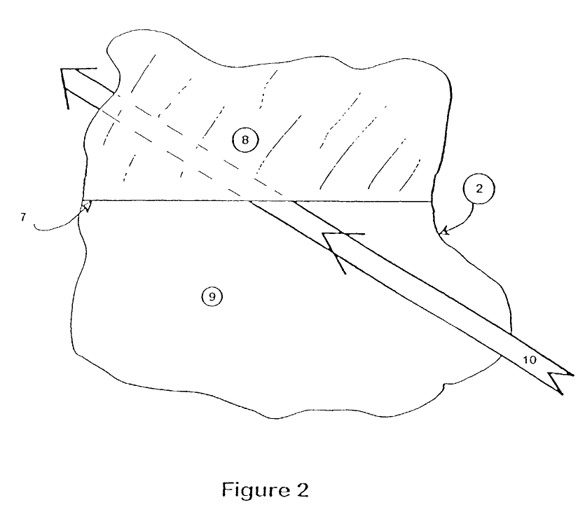

Referring to FIGS. 1a and 1b, the valve consists of a flat mirror, 1, placed at a short distance, d, from and parallel to a substrate, 2. Mirror 1 may move to different positions in a plane, 3, parallel to a surface of substrate 2, either substantially curvilinearly, as in the substantially circular, pendulum-like motion, 5 in FIG. 1c or in a substantially rectilinear motion in any direction, such as 6 or 6A in FIG. 1d. In a preferred embodiment, motion is generally parallel or normal to a base line, 7 (FIG. 2), that separates an opaque zone, 8, of substrate 2, wherethrough light 10 can not pass, from a transparent zone, 9, wherethrough light 10 can pass and wherewithin switching takes place. Transparent zone 9 may be transparent because substrate 2 exists in zone 8 and is absent in zone 9, or because the material of substrate 2 in zone 9 is transparent to the relevant wavelengths. Different embodiments of the principles disclosed here can be devised by those skilled in the art, in which it is possible to distinguish the zones in other ways.

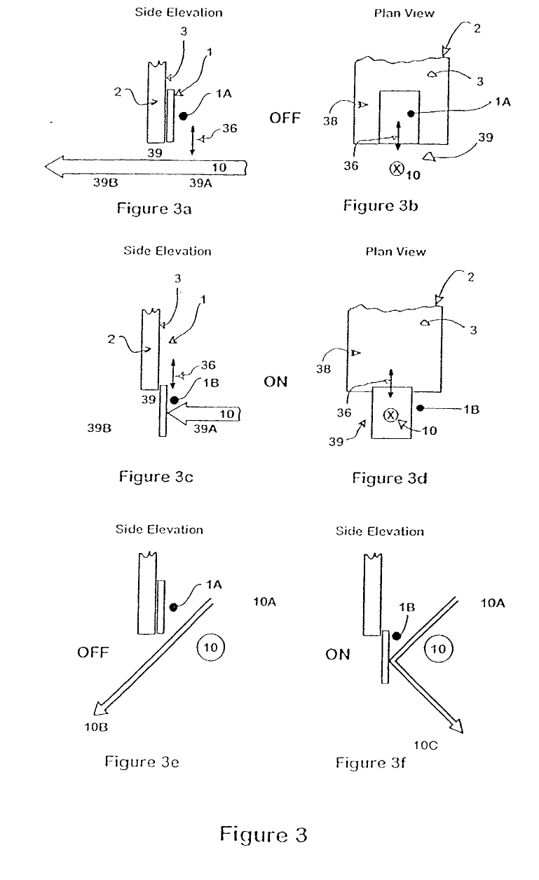

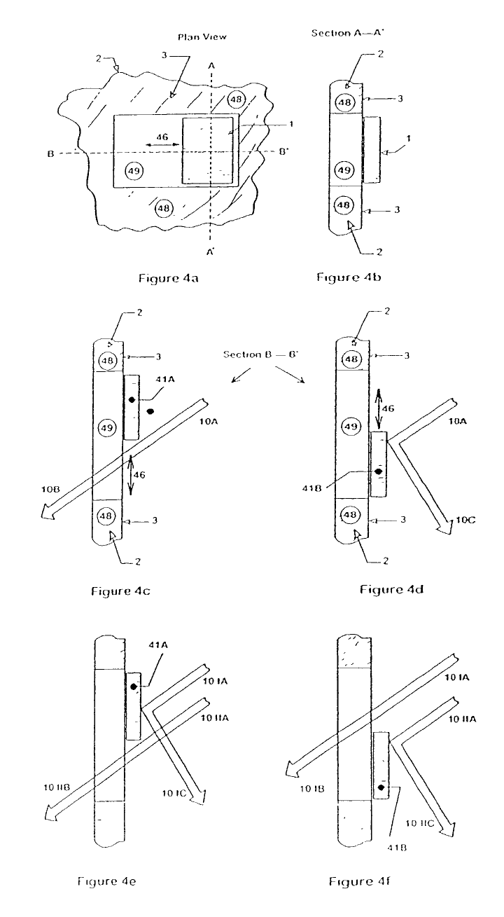

One approach is illustrated in FIG. 3. Mirror element 1 is located opposite an opaque zone, 38, of substrate, 2, while light, 10, transits unobstructed through a transparent zone, 39. In this condition, it is in an OFF state, 1A, as shown in FIG. 3a, b. Mirror 1 is movable rectilinearly, parallel to substrate 2, into zone 39, as shown by double-headed arrow 36, to an ON state, 1B (FIG. 3c, d). While mirror 1 is in OFF state 1A, light 10 can pass from one side, 39A, of surface 3 to another side, 39B, generally at an angle to said surface.

In a preferred embodiment (FIG. 3e, f) ray 10 is inclined at 45 to mirror 1. In OFF state 1A, ray 10 transits the switching zone unimpeded from 10A to 10B. When mirror 1 is in ON state 1B, light is reflected along an alternate path 10C. Thus ray 10 has one input state, 10A, and two possible, mutually exclusive, output states, 10B and 10C.

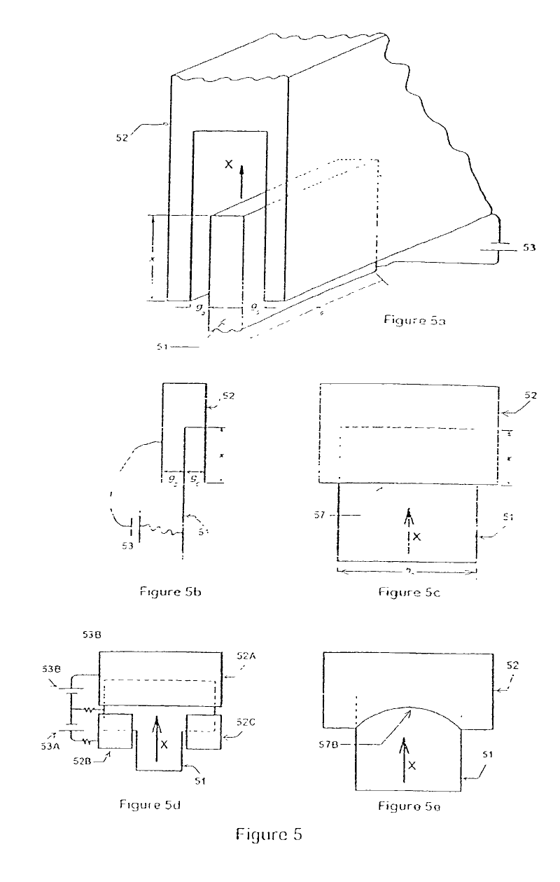

In another possible embodiment (FIG. 4), mirror 1 is movable along a line of motion 46, which lies entirely opposite a transparent part, 49, of plane 3, and, by so doing, can simultaneously create obstructing and non-obstructing states in different parts of zone 49. Mirror suspension and actuation elements are placed opposite another, opaque zone, 48, of plane 3. As previously explained, in non-obstructing state 41A (FIG. 4c), light 10A passes to exit 10B while, in blocking state 41B, light is reflected to an alternate output 10C. In this configuration, where mirror 1 is entirely opposite transparent zone 49, either position of mirror 1 can be designated as ON or OFF (FIG. 4e, f). Thus, it is possible to have a valve with two parallel inputs, 10 IA and 10 IIA, being in an ON state for the former, reflecting ray 10 IA to output 10 IC, while being in an OFF state for the latter, which passes to output 10 IIB (FIG. 4e). On actuating switch 1, these states reverse and input ray 10 IA is in an OFF state transiting to output 10 IB, while input ray 10 IIA is in an ON state, reflecting to output 10 IIC. This makes a (1×2)×2 exchange switch, which may be used, for example, in a Banyan network.

More elaborate applications can be realized by combining two or more switching elements. It is important to note that the rays can traverse the switch in the reverse direction. In this case, inputs interchange with outputs and the switching options, explained above, are reversed.

Actuation.

The valve consists of mirror 1 which is movable parallel to surface 3 and may be in at least two rest positions. Mirror 1 reflects light at one position and allows its passage at the other. A number of methods of actuating the valve are possible: thermal, magnetic, piezoelectric, mechanical, electrostatic actuation and actuation methods that rely on shape memory alloys are a few of many actuation methods known in the art.

Electrostatic Envelope Actuation.

A preferred embodiment uses electrostatic actuation. Different schemes of electrostatic actuation can be used, among them a comb-drive mechanism. (Hirano T. et al, “Design, Fabrication, and operation of submicron-gap comb-drive microactuators”, Journal of Microelectromechanical Systems, vol. 1 No. 1, Mar. 1992, page 52.) In conventional comb-drive actuation, the actuation force depends on the change of the overlapping area between the driver's fingers and comb. Since usual fabrication methods limit that area to a small value, a large number of fingers is necessary to produce the required force. Therefore this kind of actuation is generally slow and requires large actuators. A different approach to this actuation principle is disclosed here (FIG. 5).

Overlapping finger 51 and comb 52 form a capacitor (FIG. 5b). The attractive force between the movable and static fingers is:

$$F = - \frac{\partial U}{\partial x}$$

$$where U = \frac{1}{2} {CV}^{2}$$

is the electric energy stored in the capacitor of capacitance C. The capacitance of a parallel-plate capacitor is determined by the geometric parameters thereof and depends linearly on the area (A) and inversely on the gap between the electrodes (g₀). In the case considered here:

$$C = {ϵ}_{0} \frac{A}{{g}_{0}} = {ϵ}_{0} \frac{{h}_{0} x}{{g}_{0}}$$

The force is, therefore:

$$F = - \frac{{ϵ}_{0} {V}^{2} {h}_{0}}{2 {g}_{0}}$$

where, ε₀ is the permittivity of the vacuum, V an electrical potential 53, h₀ is width of the finger, x is the overlapping length of the finger in the direction of advance thereof, and g₀ is the gap between the moving finger and the static fingers. It is seen that the force is inversely proportional to the gap between the fingers and proportional to the width of the fingers. It does not depend on the thickness or the amount of overlap between moving and static fingers. Based on this conclusion, in order to achieve more force and thus faster switching speed, a configuration is disclosed in which the width of the finger is increased.

The production of wide fingers is generally difficult with conventional previous art. A fabrication method is disclosed in which the manufacture of wider fingers is easily done. Thus, fewer fingers, or even a single finger, can achieve sufficient force and thus faster switching times of the order of microseconds, compared to milliseconds with previous art. The disclosed actuator has an envelope-like configuration in which mirror/finger (moving electrode) 51 may enter or exit envelope (static actuating electrode) 52.

In another embodiment (FIG. 5d), at least two actuating electrodes are placed in a way that one set, 52A, actuates to an ON position while the other, 52B, C, actuates to an OFF position. Actuation can be made bistable: if the actuated mirror is supported by buckled beams a snap action to each position of the mirror results.

Another possible embodiment to implement bistability employs electrostatic snap (pull-in) action. The actuated element is attracted and adhered to an electrical isolated electrode at the end of its motion.

From the equations above, force exerted is given by:

$$F = - \frac{1}{2} {ϵ}_{0} \frac{{V}^{2}}{{g}_{0}} \frac{\partial A}{\partial x}$$

Since force depends on the change of area A with displacement x, the area change of this actuator should be enlarged, not only the width of the finger. Thus, for the actuator presented, the force can be enlarged further as follows: If the change in position is regarded as constant, ax, then it is possible to enlarge the attack-front perimeter (57, FIG. 5c) the electrode crosses. In other words, the actuating electrodes entering line (57) should be enlarged. This line can be designed to be circular (57B, FIG. 5e) instead of straight. This will enlarge the front from h₀

$$\frac{π {h}_{0}}{2}$$

and the force increases correspondingly. Alternatively, or additionally, the leading edge of electrode 51 may be similarly enlarged.

Another embodiment increases the front length by using a high-perimeter geometrical form. Such a form can be an irregular form such as a fractal line designed for such application. The use of a fractal form can increase the actuating force by the ratio of its perimeter to the straight-line length.

Curved Electrode Actuation.

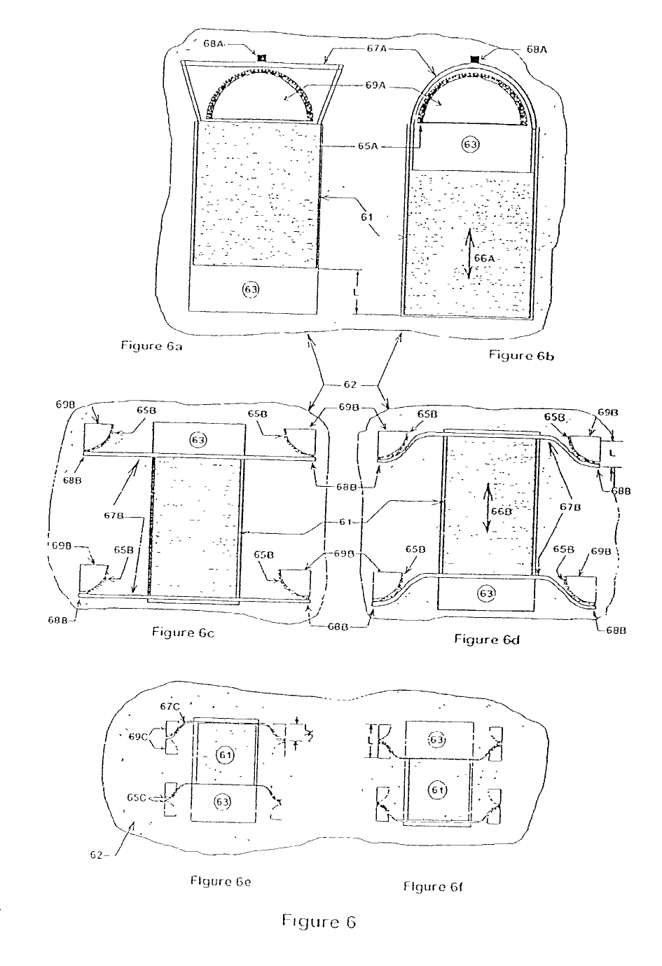

Another electrostatic actuation method is presented in FIG. 6, in which the post-fix A or B refers respectively to variant embodiments. One or more flexible beams, 67A or 67B, support a mirror, 61. One point of the beam(s), 68A or 68B, is fixed in close proximity to a circular segment stator, 69A or 69B, attached to a substrate, 62. These stators and beams are conductive and chargeable with opposite polarity. Beam 67A or 67B and stator 69A or 69B, respectively, are separated by insulators, 65A or 65B, from each other along the entire circular segment of stator 69A or 69B or, at least, at points where contact may occur, so as to prevent a short circuit (FIG. 6a, b, c, and d).

Applying a potential difference between stator 69 and moving beam 67 provides charges of opposite polarities to stator 69 and beam 67, so that the latter is attracted to the former, as close as permitted by the insulation (FIG. 6b, 6d). Removing the potential difference allows beam 67 to return to its original shape. Since a free end of beam 67 is attached to mirror 61, the consequent advance or retreat of the contact zone around the perimeter of stator 69 moves mirror 61 a distance L in a direction indicated by double-headed arrows 66A and 66B. This method is especially useful when actuating elements 67, 68, and 69 are completely within substrate 62 with mirror 61 being entirely opposite transparent zone 63, as described previously. It is a suitable alternative where envelope-type actuation is not preferred. Beams are produced curved so that actuation is inherently bistable. In order to move mirror 61 a distance L, the height of stator 69A or 69B should be L. If stator 69B is a quadrant of a circle, the height should be the circle radius and have a value of L.

Another embodiment of this actuation method (FIG. 6e, f) employs opposed-quadrant stators. In this case two quadrant-shaped stators, 69C, are separated by one single beam, 67C, so that beam 67C is tangential to both quadrants at a point of contact and both quadrants are oriented so that a radial boundary of each quadrant forms a straight line passing through the point of contact. As before, both stators are separated from beam 67C by insulating material, 65C. In this configuration, by use of opposite charges on each member of a stator pair, half of the motion is effected by one member and the other half by the other member, in sequence. This allows a more compact actuator to be constructed.

Magnetic Actuation.

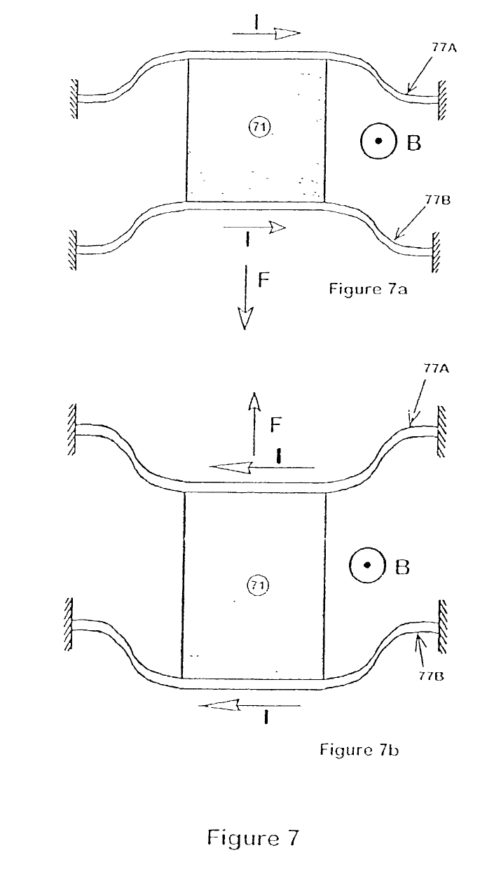

Another embodiment of the valve switch uses magnetic actuation. Magnetic fields can produce higher forces, and thus faster switching speed. The disadvantage is the larger overall volume of the device, even though the switching mechanism, itself, has the same dimensions whatever the actuation mechanism. In order to use this actuation method (FIG. 7), a magnetic field, B, is necessary at the switch. The field can be produced by conducting loops around each switch; by a permanent magnet, larger than the switch; or by an electromagnet with similar field. These are only some of the available magnetic field application possibilities.

In this embodiment of the switch, mirror 71 is supported by beams, 77A and 77B. These beams are preferably made as curved beams, in order to allow bistable operation, and are conductive or include a conducting layer wherethrough an electric current, I, may be passed. Interaction with the magnetic field induces a lateral force, F, on the beams. Appropriate alignment of the magnetic field and the current actuates mirror 71 to a new position (FIG. 7a). Reversing the current produces a reverse force that returns mirror 71 to an original position (FIG. 7b). Higher field values or higher currents produce stronger forces and faster switching.

Valve Array.

The single valve disclosed above is capable of switching light rays. Switching is possible between a single input and two outputs or two inputs into one output. The strength of the disclosed device, however, lies in its ability to switch many inputs to many outputs, within a compact space.

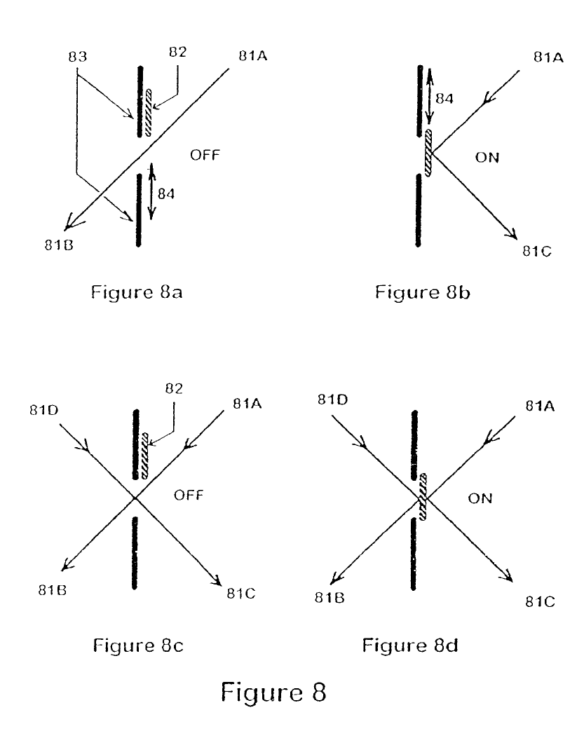

The disclosed switch can be incorporated into prior art optical devices (FIG. 8). In order to switch one input to two outputs, one mirror, 82, parallel to a substrate, 83, as disclosed before, moves in a direction parallel to substrate 83, as illustrated by double-headed arrow 84 (FIG. 8a, b). If the switch is in an OFF state, an input ray, 81A, emerges at output 81B. If the switch is actuated to an ON state, ray 81A reflects from mirror 82 and exits from output 81C. Another embodiment can be designed (FIG. 8c, d) wherein two inputs, 81A and 81D, are normal to each other and, in an OFF state, continue to respective outputs 81B and 81C. Actuating mirror 82 flips the output rays to emerge at interchanged outputs 81C and 81B respectively. In this latter embodiment, mirror 82 is reflective on both sides.

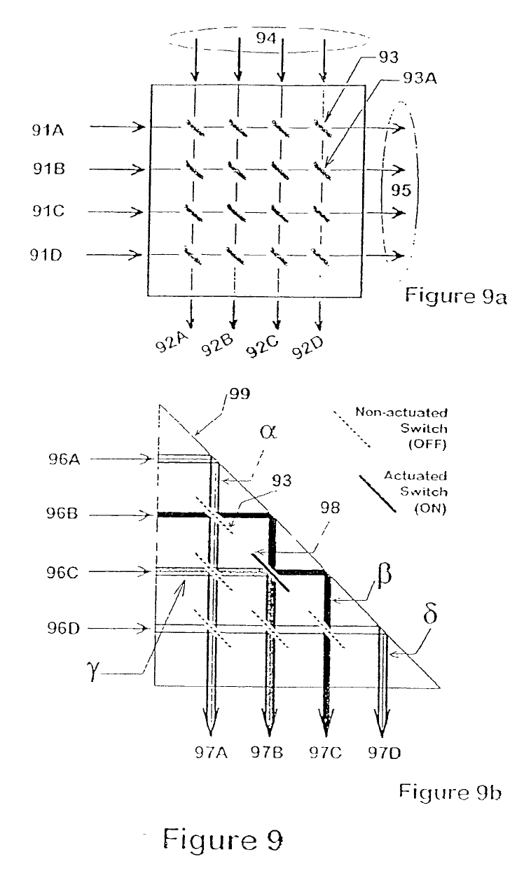

These are simple schemes, in which a single switching element is utilized. More elaborate examples can be produced by employing an array of switches (FIG. 9a). (The fabrication of such an array is discussed below.) (It should be noted that the terms “array” and “matrix” are used interchangeably herein.) A column of inputs, 91A . . . 91D, is situated normal to a row of outputs, 92A . . . 92D, in the same plane. At an intersection of each input line with an output line, a switching mirror, 93 for example, is placed, at an oblique angle to the intersecting input line 91 and output line 92. The preferred angle is 45, as drawn. It is emphasized that each input can act as an output, and vice versa, by reversing the direction of ray propagation. In order to switch any input to any output, an appropriate switching mirror 93, at an intersection of corresponding input and output axes is actuated to an ON state. The input is thus redirected to a desired output. For example, input 91B may be directed to output 92D by actuating switch 93A. Since only a one-to-one correspondence is implemented (in the case that broadcast is not implemented), only a single switch is actuated at any time in each row and in each column. A non-blocking condition exists. When partly transmissive mirrors are used to allow broadcasting, “blocking” is allowed, in the sense that a light ray that enters the array along a row of switches may traverse two or more actuated switches, with a reflected ray being directed along the column of each actuated switch. Another point should be emphasized. Although the inputs and outputs are generally normal to each other, more complicated switching operations, as basically described in FIGS. 8c and 8d, can be achieved by placing additional inputs, 94, or outputs, 95, outside the switching array, collinear with the original outputs and inputs respectively. In order to use these additional outputs (or inputs), as explained before, switches such as the switch illustrated in FIGS. 8c and 8d are used, and no switches should be actuated along the particular ray path concerned. All the switches of the respective input (or all the switches of the respective output, in the case of additional input) should not be actuated thus allowing unimpeded passage of the rays.

In FIG. 9b, another embodiment is presented in which only half of an array is needed. In this case, a static reflecting element, such as a mirror 99, as shown, or a waveguide termination, is placed at a diagonal of the array and that part of the array behind mirror 99 is discarded. (More elaborate effects may be obtained by placing, instead, actuatable mirrors at the array diagonal.) All actuatable mirrors are double sided. In this configuration, fewer actuatable elements are required to achieve desired output configurations, with the same ray path-length, although a ray may, thereby, encounter more reflecting surfaces, leading to greater light loss. Moreover, the overall switch is smaller, which is an advantage in some fabrication schemes, as will be shown below. In the example of FIG. 9b, inputs 96A, B, C, and D, are switched to outputs 97A, C, B, and D respectively. Input 96A is reflected to output 97A via path a and input 96D is reflected to output 97D via path b; it can be seen that these require no switching. Input 96B is, however, switched to output 97C via path P by reflecting at a back of actuated mirror 98. At the same time, input 96C is switched to output 97B via path y by reflecting at mirror 98.

Although the embodiment shown has no broadcast possibility, this is not a restrictive example. Other embodiments can be devised wherein broadcasting is available. Such embodiments include mirrors that are partially reflective and partially transmissive. In such cases, more than one mirror is actuated, to produce broadcasting. Other schemes for broadcasting and multicasting can be designed by those skilled in the art, using the presented building blocks.

Most of the previous features of the array of switches are known from previous art and are applied to the specific embodiments disclosed here. In the case of small arrays, the number of switches is small and the short optical paths cause only small power losses. Some applications, however, require large numbers of inputs and outputs. For a 10×10 array, 100 switches are required. A 50 pm separation between switches will result in a longest path length of −1 mm. For a 100×100 array, however, 10,000 mirrors are required and the longest path length is 1 cm. The large increase in dimensions and number of switches results in increased device losses.

A more elaborate switching device is now disclosed in which shorter paths and fewer switches are possible. The disclosed device enables this switching option. Other types of switches, both of the MEMS (microelectromechanical system) type, as is the switch of the present invention, and of other types (lithium niobate, liquid crystal, etc.), are also configurable in the arrays of the present invention, with MEMS switches being preferred.

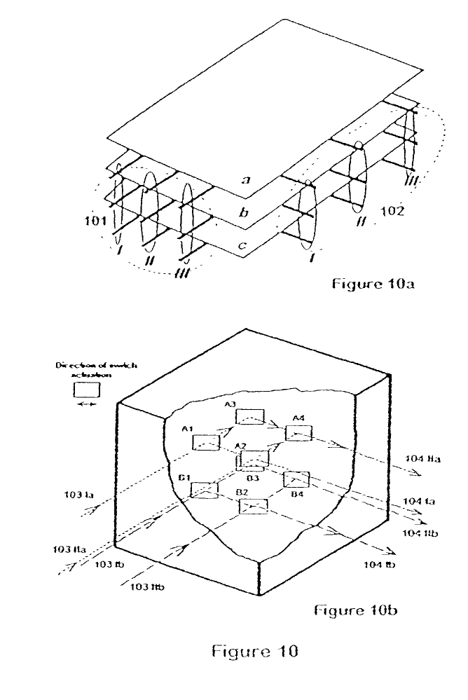

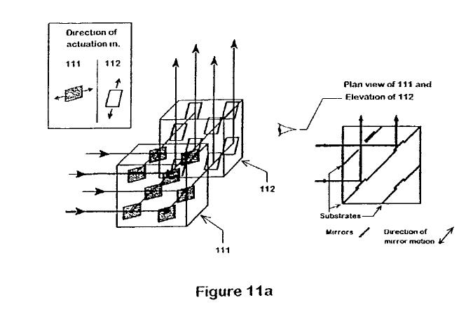

An embodiment of this more elaborate device is presented schematically in FIG. 10a. In an example of this embodiment, three switching arrays, a, b, and c, as described in FIG. 9a or 9b, are utilized, the arrays being stacked, with corresponding elements vertically above one another. Each array operates either independently of the other arrays or in conjunction therewith. As will be seen below, the arrays are not merely stacked, but may be mutually coupled, to achieve more efficient switching, in a smaller volume, than is possible using prior art switch arrays.

Inputs, 101, consist of stacked rows, denoted by a, b, c, and vertical columns denoted by I, II, III. Outputs, 102, are similarly denoted. There is now a two-dimensional input array to a three-dimensional switch, leading to a two-dimensional output array. (The previously described device had a one-dimensional input array to a two-dimensional switch, leading to a one-dimensional output array.) Easy fabrication of this device is described below.

A realization of this arrangement is shown in FIG. 10b, where a cut-away view of a two layer array having four switching mirrors in each layer is shown, oriented similarly to the schematic view in FIG. 10a. In this, inputs 103 may lead to outputs 104. The upper layer has inputs 103 la and 103 IIa and outputs 104 la and 104 IIa, and switching mirrors A1, A2, A3, and A4; its possible light paths are illustrated by dotted lines. The lower layer has inputs 103 Ib and 103 IIb and outputs 104 Ib and 104 IIb, and switching mirrors B1, B2, B3, and B4; its possible light paths are illustrated by dashed lines. Not all light paths will be followed in any given instance. There is no interaction between the two layers.

The same FIG. 10b can also illustrate the smallest realization of the half-array switch illustrated schematically in FIG. 9b. In this case, mirrors A1, A4, B1 and B4 are fixed, mirrors A3 and B3 are absent, and mirrors A2 and B2 are actuable, as before, and also reflective on both sides. Light paths beyond mirrors A1, A4, B1 and B4 will no longer be possible. As in the previous paragraph, there is no interaction between the two layers.

In a first 3D embodiment presented, there is no correlation between input rows. A basic use of this stack is connecting a number of inputs to outputs within a small space. The only advantage of this device is a saving of space. A more important use can, however, be envisioned for WDM (wavelength division multiplexing) networking wherein each plane is assigned to a different wavelength, there being a sufficient number of planes for the number of wavelengths, so that all inputs in each plane have the same wavelength. Previously separated wavelengths are conducted to the appropriate planes. For each wavelength, a 2D switching matrix routes inputs to desired outputs. These outputs are subsequently recombined for further transmission or other use.

Although inputs 101 and 103 and outputs 102 and 104 are illustrated in FIG. 10 as being at right angles to each other, it will be appreciated that the switch array of the present invention may be configured with inputs and outputs at any convenient non-zero angle to each other.

Multi-Layer Switching. Another use of the 3D switching matrix shown in FIG. 10 is in compact switching of a large number of inputs. The main purpose of this use is the reduction of a ray path-length and the number of switches necessary compared with a square switching array. Instead of using a 2D array with a ID column of inputs and outputs, a 2D input matrix is utilized. Each plane, a, b, and c, consists of a non-blocking array. Such an array can be regarded as an operator that transforms the input row, 101 Ia, 101 IIa, 101 IIIa, at plane a, to output row, 102 Ia, 102 IIa, 102 IIIa, at plane a, and so on for the other planes. Since each plane is isolated from neighboring planes, the only possible operator action is to change the column index, I, II, III, . . . , between input and output.

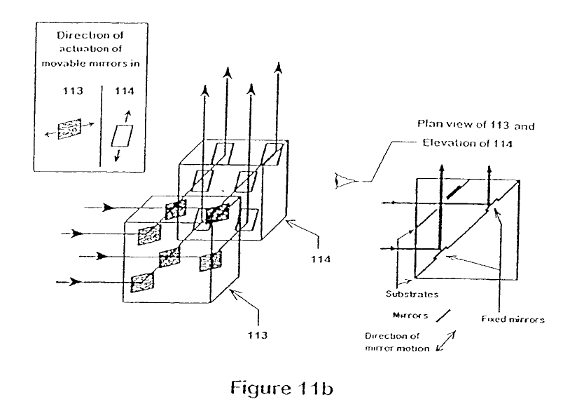

This is not enough; what is required is the capability to switch any input array element to any output array element. The 3D operator of the preceding paragraph is able to change only the column index of each element in the input matrix. This can be overcome by a double application of the 3D operator wherein rows and columns at the output of the first stage are transposed into columns and rows at the input of the second stage. This second application of the operator will again change only the column index within each row of the second matrix, but this time the column indices are the former row indices. Thus, by applying the 3D operator represented by the 3D switching matrix twice in succession, with intermediate transposition, the necessary switching can be accomplished. FIG. 11a illustrates the disposition of switching elements.

Practically, after rays transit a first switching matrix (111) emerging rays are introduced into a second similar switching matrix (112), rotated 90 with respect to matrix 111. Matrix 112 may be switched differently from matrix 111. A non-blocking switching can be achieved. A third switching matrix can be incorporated if the resulting overall switching is not sufficient for the application. In this case, the third matrix is rotated 90 with respect to matrix 112. In this case, too, non-blocking states are obtained, but the non-blocking path that connects any given input to any given output may not be unique. As an example of the advantage gained by this design, consider the task of switching any or several of 100 inputs to any or several of 100 outputs (a 100×100 switch). To perform the task, three matrices are needed, with the second matrix rotated 90 with respect to the first matrix and with the third matrix rotated 90 with respect to the second matrix. Each switching matrix consists of a 10×10×10 cube, with 1000 switches. A total of 3000 switches are used. The longest optical path, for a switch separation of 50 pm, is (10+10+10+10+10)×50 pm=2500 pm=2.5 mm. This compares with 10,000 switches and a 1 cm optical path needed to perform the same task with a conventional 2D array.

In FIG. 11b is illustrated an equivalent switch array complex using the 3D switching matrix of FIG. 9b instead of that of FIG. 9a, utilizing fixed mirrors along a diagonal of each matrix. In this case, a 100×100 switch requires only 1350 switches, not including the 100 fixed switches, along the diagonal.

As in the case of the two-dimensional matrix of FIG. 9a, the three-dimensional arrays of FIGS. 10b and 11a can be configured with switches such as the switch illustrated in FIGS. 8c and 8d; providing the option of placing the arrays in switching states in which some or all input rays traverse the array without being reflected. In this case, too, special options, such as control, can be implemented. A 3D matrix need not be cubic and the input array may be, for example 10×10, 10×3, etc., provided that the second, rotated 3D matrix has a matching number of rows and columns. For a six-input matrix, arranged as a 3×2 array, two planes of 3×3 arrays are needed. The second cube then needs three planes of 2×2 arrays.

Based on the elements presented, those skilled in the art may find other variations covered by this invention. One possible variation is to alter the number of cubes used, applying one, two, three, four, etc., cubes as required.

Wavelength De-multiplexing.

Another embodiment includes the addition of a wavelength demultiplexing/multiplexing system to the above methods for use of the disclosed switch in WDM (wavelength division multiplexing). In this embodiment, information is transmitted through optical fiber, encoded within a group of different wavelengths. A wavelength de-multiplexing and multiplexing device is necessary to separate the different wavelengths at the entrance to a switch array and, after processing or use, recombine these wavelengths. Rays introduced into the described switch are preferably parallel to one another. A device that can accomplish this is presented.

Several technologies for wavelength separation exist. Among them, the use of diffraction gratings is popular. The embodiment introduced below uses a diffraction grating to separate the wavelengths into parallel rays that can be introduced into a 3D switch. A similar device receives and recombines the output bundle of parallel rays for insertion into a fiber.

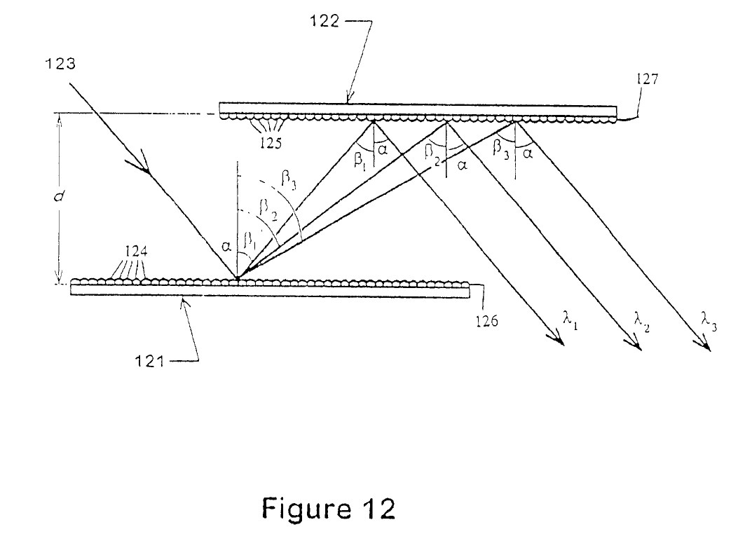

The device used (FIG. 12) includes two parallel reflective diffraction gratings, 121 and 122, each with respective diffractive elements such as parallel rulings 124 or 125 on surfaces 126,127 that face each other. The distance between the separated wavelength rays is determined by parameters including the distance d between parallel diffraction gratings 121 and 122 and the spacing of parallel rulings 124,125.

A collimated input beam, 123, emerging from a fiber, is incident on a surface 126 of a first diffraction grating, 121, at a predetermined angle, a. A simple mirror would reflect this beam at the same angle with respect to a normal to the surface of the mirror. A grating, however, diffracts different wavelengths (],2, . . . ) at different angles (1, 2, 3,,,,); the sum of incident angle plus angle of diffraction is a function of wavelength. From this, it is clear that different wavelengths will be separated into different angles at diffraction grating 121.

Since the relation between the input and output angles is the same for second diffraction grating 122 as for first diffraction grating 121, and since the diffraction gratings are parallel, the reflected angle from second diffraction grating 122 is equal to the angle of incidence, a, at first diffraction grating 121. Since this angle a is equal for all wavelengths, rays of all wavelengths emerge parallel, displaced from one another, and at angle a, after reflecting from second diffraction-grating 122. With this configuration, wavelengths are separated into parallel rays, with displacement depending upon inter-reflection-grating distance d, incident angle a, and the spacings of rulings 124 and 125.

Since the ray paths are reversible, reversing direction provides a device capable of recombining wavelengths before insertion into a fiber on output. The use of one device at an input to the matrix and a reversed one at an output allows de-multiplexing, switching, and multiplexing signals in a WDM network.

Fabrication.

The three-dimensional arrays of the present invention may be fabricated using prior art technologies, albeit at a cost that may be uneconomical or impractical. Therefore, the scope of the present invention includes an innovative method of fabricating these arrays. The basic device is fabricated on top of a wafer surface, in contrast to previous art, where the mirrors may be etched into the substrate. The mirrors, which require substantially perfect surface quality, flatness, and parallelism, take advantage of high-quality substrates prepared for the microelectronics industry. Substrates of various dimensions, thicknesses, materials, and surface preparations are available.

Generally, the device can be prepared on any kind of material and the fabrication procedure is independent of substrate material. While the substrate material has no effect on the switches, apart from surface preparation and physical dimensions, it is possible to take advantage of the substrate's properties. For example, electronic circuitry may be integrated into the substrate or optical fibers may be set therein, in which case advantage can be taken of features such as the crystallographic planes of the substrate material, as in silicon. Those skilled in the art may find different materials and techniques for the production of these switches.

Single-Switch Fabrication.

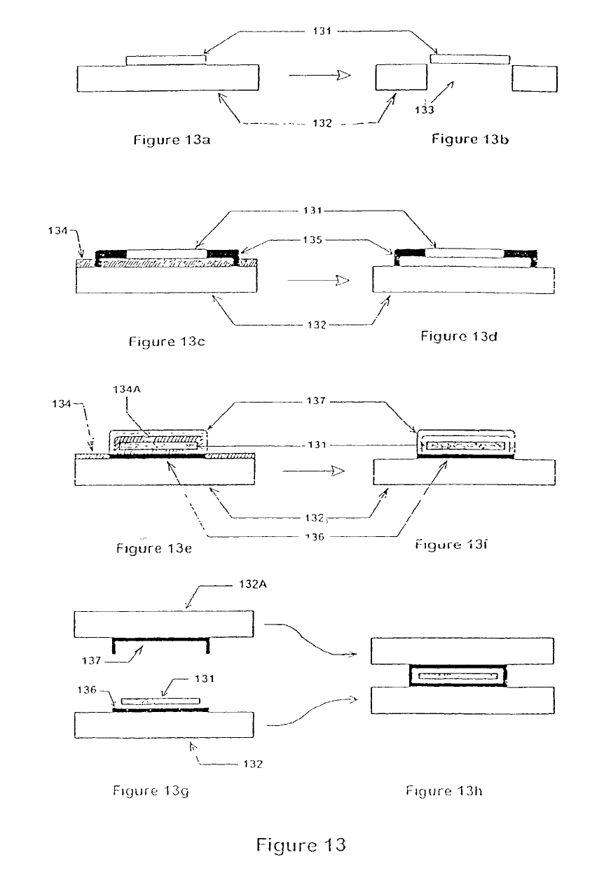

Fabrication starts with a substrate, 132 (FIG. 13). Mirror material, 131, generally a metal such as aluminum, is deposited on substrate 132 and patterned using standard methods such as lithography. Generally, mirror 131 is produced on top of substrate 132 at a zone, 133, where substrate material eventually will be absent so that a ray may pass through (FIG. 13b).

In another fabrication procedure (FIG. 13c, d), mirror 131 is fabricated above a portion of substrate 132 where substrate material eventually will be present. In this case a sacrificial layer, 134, is deposited on top of substrate 132; patterned, if necessary, to allow the deposition of subsequent layers that must penetrate through sacrificial layer 134 to reach substrate 132; and polished prior to deposition and patterning of mirror 131. Along with mirror 131, supporting beams 135 are deposited and patterned above sacrificial layer 134. Supporting beams 135 can be made of any material; in many cases they are made of metal or are otherwise conductive. Supporting beams 135 are fabricated attached to mirror 131 and substrate 132. The number and configuration of supporting beams 135 depend on the application.

After deposition and patterning of the mirror 131 and supporting beams 135, these moving elements are released by dissolving sacrificial layer 134 (FIG. 13d) or by etching away substrate 132 under mirror 131 (FIG. 13b). These procedures free mirror 131 and beams 135. Further fabrication steps depend on the actuation mechanism.

Fabrication of electrodes and conducting lines can be done together, before or after the above-mentioned steps.

In case of envelope/comb actuation (FIG. 13e, f), an electrode, 136, is deposited on substrate 132 and covered by a sacrificial layer (134). The above-mentioned steps for fabrication of mirror 131 are carried out on top thereof. A second electrode of the envelope can be produced in a few ways. In one way (FIG. 13e, f) mirror 131 is covered by a second sacrificial layer, 134A. Second layer 134A is patterned and covered by a second envelope electrode, 137, which is patterned. By removing the sacrificial layers, the envelope is formed and mirror 131 is released.

Another possibility is depositing and patterning a second envelope electrode 137 on another side of substrate 132 or, as illustrated in FIG. 13g, on another substrate, 132A. By aligning and bringing together a mirror side of substrate 132 and a second-electrode side of substrate 132A, and bonding, an envelope is formed (FIG. 13h). Bonding is done by one of the known wafer-bonding methods, such as fusion bonding. Spacers and electrical connection paths are deposited and patterned as required prior to alignment and bonding.

In the case of curved electrode actuation, the mirror can be processed directly on a wafer surface at a ray traverse zone. Supporting beams are deposited and patterned on top of the mirror, as previously explained. It is possible to deposit material for the static curved electrode and to do the patterning simultaneously, followed by insulation deposition and patterning over the static electrode. Etching the sacrificial layer and corresponding substrate area releases the movable elements.

In the case of magnetic actuation, the supporting beams may act also as conducting lines, and there is no need for further fabrication steps. The mirror and beams are fabricated and released.

Other methods for single-switch fabrication can be devised by those skilled in the art. It is emphasized, however, that the choice of fabrication method on the substrate surface is advantageous to obtaining good quality mirrors and acquiring better control over alignment of the mirrors.

Switch Array Fabrication.

The construction of a switch array requires more elaborate methods than single-switch fabrication. The disclosed method is designed to facilitate accurate construction of a 3D cubic array.

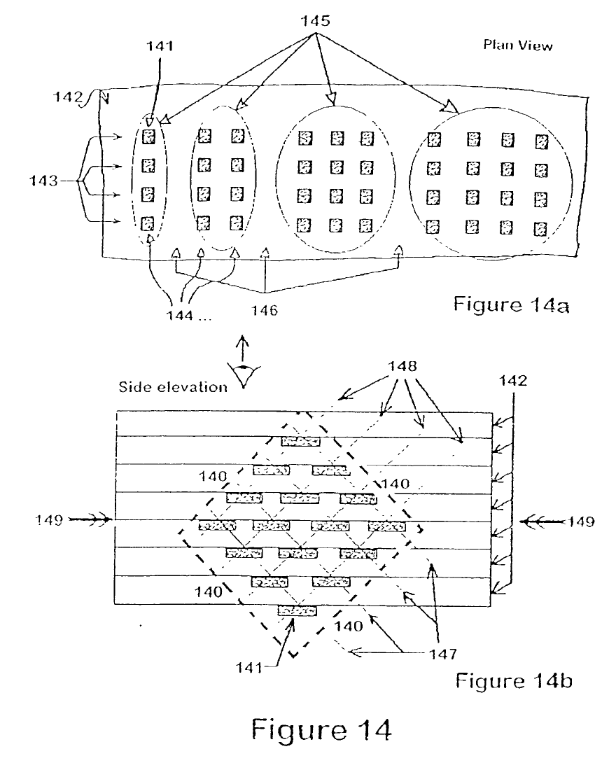

In order to simplify understanding of the fabrication method, a 4×4×4 array is described (FIG. 14). This is only an illustrative example and does not limit the applicability of the method.

Single switches, 141, are produced, as described previously, in rows, 143, on a surface, 142, of a substrate. In our example, there are four rows. These switches are also arranged in groups, 145, of regularly spaced columns, 144, each group being separated from a neighboring group by an empty column, 146, at the same column spacing. The first group of our example consists of one column of four rows, separated by an empty column from a second group consisting of two columns of four rows followed by another empty column. The arrangement continues with successive groups of 3×4 and 4×4 to form a set. An entire wafer may be covered with such sets. For our example, at least seven such sets are required.

In order to fabricate a box array, these sets are carefully aligned, each on top of another, and bonded. A first set is placed at the bottom ready for an alignment (FIG. 14b). A second wafer is aligned on top of and parallel to the first, with a second group of columns (2×4) centered above a single-column group of the first wafer. This alignment is obtained by suitably displacing the second wafer with respect to the first, in a direction parallel to rows 143. This procedure is continued with consecutive wafers, a 3×4 group of columns being centered above the 2×3 group, and a 4×4 group being centered above the 3×4. Stacking is then continued in a reverse order, a 3×4 group being centered above the 4×4 group, and so on, until a 1×4 group is placed on top of a second 2×4 group. The stack is then bonded. Viewed from the side, it is seen that the mirrors form a 2D matrix having column, 147, and row, 148, directions oriented at 45° to the surfaces of substrates 142. The mirrors are oriented at 45 to these column and row directions. In this example, the array is four deep.

If the configuration shown in FIG. 9b is fabricated, only half of the above array is required. One set of switching mirrors, at a reflecting middle plain, 149, is replaced by a plain static mirror substrate and the mirrors on the non-reflective side of plain 149 are not required.

After bonding is completed, accurate dicing is performed, preferably parallel to columns 147 and rows 148 of the mirror array, along the lines 140. A cubic array of mirrors results. This array is further packaged by aligning with input and output fibers. It is also possible to align two or more such cubes and to rotate one with respect to the other so that a 3D-switching device, as explained before, is produced.

Similar steps are followed to produce arrays of other dimensions, including rectangular arrays that are not square.

Operation.

These switches are actuated by one of the previously specified methods through conducting lines which connect rows, columns, and planes, as appropriate. By applying an appropriate voltage or current to a particular mirror, that mirror may be set or reset into an ON or Off position.

It is readily apparent, in FIG. 14, that these switches may be actuated by moving their mirrors in one of two orthogonal directions: a first direction, in the planes defined by columns 147 and rows 148, at 45 angles to columns 147 and rows 148 (left-right in the plane of FIG. 14); and a second direction, in and out of the planes defined by columns 147 and rows 148 (in and out of the plane of FIG. 14); or in a linear combination of these two orthogonal directions.

Applications.

The switch presented can be used for switching input rays of different wavelengths from numerous input paths to numerous output paths. It is primarily intended for use in communications. Together with the wavelength separation and re-combination device disclosed above, it is applicable to WDM. Other applications, such as in optical computation, etc., will be evident.

While the invention has been described with respect to a limited number of embodiments, it will be appreciated that many variations, modifications and other applications of the invention may be made.

What is claimed is:

1. A MEMS device for optically attenuating an optical beam, comprising:
a microelectronic substrate having a generally planar surface;
a microelectronic actuator disposed on the generally planar surface of said microelectronic substrate; and
an optical shutter disposed on the generally planar surface of said microelectronic substrate, wherein said optical shutter is actuatable by said microelectronic actuator and is adapted to be held at any one of a plurality of positions, and wherein said optical shutter is configured to block a different percentage of optical power in each position such that said optical shutter can block any percentage of optical power within an optical power range.

2. A MEMS device according to claim 1, further comprising:
an electrostatic clamping element disposed on said substrate and operably connected to said optical shutter that allows for said optical shutter to be electrostatically clamped at a desired attenuation position;
an electrostatic contact on said substrate which is electrostatically coupled to said electrostatic clamping element; and
means for applying an electrostatic force between said electrostatic clamping element and said electrostatic contact.

3. A MEMS device according to claim 2, wherein said electrostatic clamping element is comprised of a metal.

4. A MEMS device according to claim 2, wherein said electrostatic clamping element is comprised of a semiconductor-metal composite.

5. A MEMS device according to claim 1, wherein said microelectronic actuator further comprises a thermal actuator.

6. A MEMS device according to claim 5, further comprising a means for applying heat to said thermal actuator to cause further actuation of the thermal actuator, thereby actuating said optical shutter.

7. A MEMS device according to claim 6, wherein said means for applying heat further comprises an external heater disposed proximate to said actuator.

8. A MEMS device according to claim 5, further comprising an actuator member that is configured to be displaced by said thermal actuator and attaches said optical shutter to said thermal actuator.

9. A MEMS device according to claim 1, further comprising a support structure for supporting said optical shutter on said substrate.

10. A MEMS device according to claim 9, wherein said support structure further comprises a folded beam suspension structure.

11. A MEMS device according to claim 1, wherein said microelectronic actuator further comprises an array of microelectronic actuators.

12. A MEMS device according to claim 1, wherein first and second actuators actuate in generally the same plane and in generally opposite direction within the plane.

13. A MEMS device according to claim 1, wherein said optical shutter is of a predetermined shape that allows for complete attenuation of the optical beam.

14. A MEMS device according to claim 1, wherein said optical shutter is of a predetermined shape that allows for partial attenuation of the optical beam.

15. A MEMS device according to claim 1, wherein said optical shutter is generally block shaped.

16. A MEMS device according to claim 15, wherein said optical shutter has a predetermined thickness along the faces of the generally block shaped optical shutter.

17. A MEMS device according to claim 1, wherein said optical shutter has a contoured surface.

18. A MEMS device according to claim 1, wherein said optical shutter comprises a metal.

19. A MEMS device according to claim 1, wherein said optical shutter comprises a semiconductor-metal composite.

20. A MEMS device according to claim 1, wherein said microelectronic substrate defines an opening therethrough, the opening allowing for the passage therethrough of the optical beam.

21. A MEMS device according to claim 20, wherein the optical beam has an optical axis generally perpendicular to the generally planar surface of said microelectronic substrate and said optical shutter lies in a plane generally parallel to the generally planar surface of said microelectronic substrate.

22. A MEMS device according to claim 1, wherein said microelectronic substrate further defines a transparent material that allows for an optical beam to be passed therethrough.

23. A MEMS device according to claim 1, wherein said optical shutter is attached to said microelectronic actuator, lies in a plane generally parallel to the generally planar surface of said microelectronic substrate and is capable of being extended beyond an edge of said microelectronic substrate upon actuation, thereby allowing for the attenuation of an optical beam that passes along the edge of said microelectronic substrate.

24. A MEMS device according to claim 23, wherein the optical beam is in a plane generally perpendicular to the planar surface of said microelectronic substrate.

25. A MEMS device according to claim 1, wherein said optical shutter lies in a plane generally perpendicular to the generally planar surface of said microelectronic substrate.

26. A MEMS device according to claim 25, wherein said optical shutter is supported on said substrate by a hinged type structure.

27. A MEMS device according to claim 25, wherein said optical shutter is supported on said substrate by a flexible torsional support structure.

28. A MEMS device for optically attenuating an optical beam, comprising:
a microelectronic substrate having a generally planar surface; and
a moveable composite actuator disposed on the planar surface of said microelectronic substrate and adapted for thermal actuation so as to controllably move along a predetermined path and attenuate an optical beam lying in the path of actuation wherein said moveable composite actuator blocks a different percentage of optical power in each position along the path such that said moveable composite actuator can block any percentage of optical power within an optical power range.

29. A MEMS device according to claim 28, wherein said moveable composite actuator further comprises at least two layers which respond differently to thermal actuation, a fixed portion of said composite actuator attached to said microelectronic substrate and a distal portion of said composite actuator adapted to bend so as to controllably move along a predetermined path and attenuate an optical beam lying in the path of actuation.

30. A MEMS device for optically attenuating an optical beam, comprising:
a microelectronic substrate having a generally planar surface;
a microelectronic actuator disposed on the generally planar surface of said microelectronic substrate;
an optical shutter disposed on the generally planar surface of said microelectronic substrate, wherein said optical shutter is actuatable by said microelectronic actuator and is adapted to attenuate any percentage of optical power within an optical power range;
an electrostatic clamping element operably connected to said optical shutter that allows for said optical shutter to be electrostatically clamped at a desired attenuation position;
an electrostatic contact on said substrate which is electrostatically coupled to said electrostatic clamping element; and
means for applying an electrostatic force between said electrostatic clamping element and said electrostatic contact.

31. A system for variable optical attenuation, the system comprising:
a MEMS variable optical attenuator having a microelectronic substrate having a generally planar surface, a microelectronic actuator disposed on the generally planar surface of said microelectronic substrate, an optical shutter disposed on the generally planar surface of said microelectronic substrate, an electrostatic clamping element operably connected to said optical shutter that allows for said optical shutter to be electrostatically clamped at a desired attenuation position;
an electrostatic contact on said substrate which is electrostatically coupled to said electrostatic clamping element; and
a voltage source for applying an electrostatic force between said electrostatic clamping element and said electrostatic contact.

32. A method for optical attenuation using a MEMS variable optical attenuator having a microelectronic substrate having a generally planar surface, a microelectronic actuator disposed on the generally planar surface of said microelectronic substrate, an optical shutter disposed on the generally planar surface of said microelectronic substrate, an electrostatic clamping element disposed on said substrate, the method comprising the steps of:
activating the microelectronic actuator;
actuating the optical shutter by way of the microelectronic actuator so that the optical shutter is placed in a prescribed attenuation position so as to intersect at least a portion of a plane through which an optical beam passes;
activating electrostatically the clamping element thereby locking the optical shutter at the prescribed attenuation position; and
deactivating the microelectronic actuator while the optical shutter is locked at the prescribed attenuation position.

33. A method for optical attenuation using a MEMS variable optical attenuator having a microelectronic substrate having a generally planar surface, a microelectronic actuator disposed on the generally planar surface of said microelectronic substrate, an optical shutter disposed on the generally planar surface of said microelectronic substrate, an electrostatic clamping element disposed on said substrate, the method comprising the steps of:
activating the microelectronic actuator;
actuating the optical shutter by way of the microelectronic actuator so that the optical shutter is placed in a prescribed attenuation position so as to intersect at least a portion of a plane through which an optical beam passes; and
activating electrostatically the clamping element thereby locking the optical shutter at the prescribed attenuation position.

34. A method of fabricating a MEMS variable optical attenuator comprising:
forming a sacrificial layer on a generally first planar surface of a microelectronic substrate;
forming a layer on the sacrificial layer;
defining a mechanical structure of the attenuator in the layer, the mechanical structure defining an actuator, an actuator member, and an optical shutter;
releasing a portion of the layer from the substrate by etching away the sacrificial layer underlying the actuator and the actuator member; and
etching a second surface of the microelectronic substrate, opposite the first surface, and etching the sacrificial layer underlying the optical shutter to release the optical shutter from the substrate.

35. The method of claim 34, wherein said defining step further defines the mechanical structure as including a clamping element and said releasing step further includes the etching away of the sacrificial layer underlying the clamping element.

36. The method of claim 35, further comprising the steps of:
defining an electrode on the first surface of said substrate to provide an electrical connection for the clamping element.

37. The method of claim 34, wherein said defining a mechanical structure step further comprises the substeps of:
patterning a mask defining the mechanical structure on the layer; and
etching away the layer in accordance with patterned mask to define the mechanical structure.

38. The method of claim 34, wherein said forming the layer step further comprises fusion bonding a single crystal silicon layer to the substrate and oxide construct.

39. A method of fabricating a MEMS variable optical attenuator comprising:
forming a sacrificial layer on a generally first planar surface of a microelectronic substrate;
forming a silicon layer on the sacrificial layer;
defining a mechanical structure of the attenuator in the silicon layer, the mechanical structure defining an actuator, an actuator member, and an optical shutter;
releasing a portion of the silicon layer from the substrate by etching away the sacrificial layer underlying the actuator and the actuator member; and
etching a second surface of the microelectronic substrate, opposite the first surface, and etching the sacrificial layer underlying the optical shutter to release the optical shutter from the substrate.

40. The method of claim 39, wherein said defining step further defines the mechanical structure as including a clamping element and said releasing step further includes the etching away of the sacrificial layer underlying the clamping element.

41. The method of claim 40, further comprising the steps of:
defining an electrode on the first surface of said substrate to provide an electrical connection for the clamping element.

42. The method of claim 39, wherein said defining a mechanical structure step further comprises the substeps of:
patterning a mask defining the mechanical structure on the silicon layer; and
etching away the silicon layer in accordance with patterned mask to define the mechanical structure.

43. The method of claim 39, wherein said forming the silicon layer step further comprises fusion bonding a single crystal silicon layer to the substrate and oxide construct.

44. A MEMS device for optically attenuating an optical beam, comprising:
a substrate having a generally planar surface;
an actuator disposed on the generally planar surface of said substrate; and
an element disposed on the generally planar surface of said substrate, wherein said element is actuatable by said actuator and is adapted to be held at any one of a plurality of positions, and wherein said element is configured to block a different percentage of optical power in each position such that said element can block any percentage of optical power within an optical power range.

45. A MEMS device according to claim 44, further comprising:
means for electrostatically clamping said element at a desired attenuation position.

46. A MEMS device according to claim 44, further comprising a support structure for supporting said element on said substrate.

47. A MEMS device according to claim 44, wherein said element is of a predetermined shape that allows for complete attenuation of the optical beam.

48. A MEMS device according to claim 44, wherein said element is of a predetermined shape that allows for partial attenuation of the optical beam.

49. A MEMS device according to claim 44, wherein said element is generally block shaped.

50. A MEMS device according to claim 49, wherein said element has a predetermined thickness along the faces of the generally block shaped element.

51. A MEMS device according to claim 44, wherein said element has a contoured surface.

52. A MEMS device according to claim 44, wherein said element comprises a metal.

53. A MEMS device according to claim 44, wherein said element comprises a semiconductor-metal composite.

54. A MEMS device according to claim 44, wherein the optical beam has an optical axis generally perpendicular to the generally planar surface of said substrate and said element lies in a plane generally parallel to the generally planar surface of said substrate.

55. A MEMS device according to claim 44, wherein said element is attached to said actuator, lies in a plane generally parallel to the generally planar surface of said substrate and is capable of being extended beyond an edge of said substrate upon actuation, thereby allowing for the attenuation of an optical beam that passes along the edge of said substrate.

56. A MEMS device according to claim 44, wherein said element lies in a plane generally perpendicular to the generally planar surface of said substrate.

57. A MEMS device according to claim 56, wherein said element is supported on said substrate by a hinged type structure.

58. A MEMS device according to claim 56, wherein said element is supported on said substrate by a flexible torsional support structure.

59. A MEMS device for optically attenuating an optical beam, comprising:
a substrate having a generally planar surface;
an actuator disposed on the generally planar surface of said substrate;
an element disposed on the generally planar surface of said substrate, wherein said element is actuatable by said actuator and is adapted to attenuate any percentage of optical power within an optical power range;
an electrostatic clamping element operably connected to said element that allows for said element to be electrostatically clamped at a desired attenuation position;
an electrostatic contact on said substrate which is electrostatically coupled to said electrostatic clamping element; and
means for applying an electrostatic force between said electrostatic clamping element and said electrostatic contact.

60. A system for variable optical attenuation, the system comprising:
a MEMS variable optical attenuator having a substrate having a generally planar surface, a actuator disposed on the generally planar surface of said substrate, an element disposed on the generally planar surface of said substrate, an electrostatic clamping element operably connected to said element that allows for said element to be electrostatically clamped at a desired attenuation position;
an electrostatic contact on said substrate which is electrostatically coupled to said electrostatic clamping element; and
a voltage source for applying an electrostatic force between said electrostatic clamping element and said electrostatic contact.

61. A method for optical attenuation using a MEMS variable optical attenuator having a substrate having a generally planar surface, an actuator disposed on the generally planar surface of said substrate, an element disposed on the generally planar surface of said substrate, an electrostatic clamping element disposed on said substrate, the method comprising the steps of:
activating the actuator;
actuating the element by way of the actuator so that the element is placed in a prescribed attenuation position so as to intersect at least a portion of a plane through which an optical beam passes;
activating electrostatically the clamping element thereby locking the element at the prescribed attenuation position; and
deactivating the actuator while the element is locked at the prescribed attenuation position.

62. A method for optical attenuation using a MEMS variable optical attenuator having a substrate having a generally planar surface, an actuator disposed on the generally planar surface of said substrate, an element disposed on the generally planar surface of said substrate, an electrostatic clamping element disposed on said substrate, the method comprising the steps of:
activating the actuator;
actuating the element by way of the actuator so that the element is placed in a prescribed attenuation position so as to intersect at least a portion of a plane through which an optical beam passes; and
activating electrostatically the clamping element thereby locking the element at the prescribed attenuation position.

63. A method of fabricating a MEMS variable optical attenuator comprising:
forming a sacrificial layer on a generally first planar surface of a substrate;
forming a layer on the sacrificial layer;
defining a mechanical structure of the attenuator in the layer, the mechanical structure defining an actuator and an element;
releasing a portion of the layer from the substrate by etching away the sacrificial layer underlying the actuator; and
etching a second surface of the substrate, opposite the first surface, and etching the sacrificial layer underlying the element to release the element from the substrate.
